(19) United States
(12) Patent Application Publication
(10) Pub. No.: US 2020/0233336 A1
(43) Pub. Date: Jul. 23, 2020

(54) IMAGE FORMING APPARATUS AND CONTROL METHOD

(71) Applicant: Konica Minolta, Inc., Tokyo (JP)

(72) Inventor: Yoshikazu AOKI, Toyokawa-shi (JP)

(21) Appl. No.: 16/737,589

(22) Filed: Jan. 8, 2020

(30) Foreign Application Priority Data
Jan. 21, 2019 (JP) 2019-007538

(51) Int. Cl. G03G 15/08; G03G 15/00

(52) U.S. Cl. CPC G03G 15/0849; G03G 15/5045; G03G 15/0865; G03G 15/0889

(57) ABSTRACT

An image forming apparatus includes: a latent image carrier on which a latent image is formed; a developing device that stores a developer, and develops the latent image formed on the latent image carrier using the developer; a concentration acquirer that acquires a concentration of the developer stored in the developing device; an atmospheric pressure acquirer that acquires an atmospheric pressure value at a position in which the image forming apparatus is installed; and a corrector that corrects the concentration detected by the concentration acquirer, on the basis of the atmospheric pressure value acquired by the atmospheric pressure acquirer.

The entire disclosure of Japanese patent Application No. 2019-007538, filed on Jan. 21, 2019, is incorporated herein by reference in its entirety.

### BACKGROUND

### Technological Field

The present disclosure relates to an image forming apparatus and a control method.

### Description of the Related art

There are conventional image forming apparatuses using an electrophotographic method, such as copying machines, printers, facsimile machines, and multi-functional peripherals of them. An image forming apparatus normally includes a developing device, a supplier, and a sensor. The developing device contains a developer, and develops a latent image formed on a photosensitive member using the developer. The supplier supplies the developing device with the developer. The sensor detects the concentration of the developer (a toner concentration, for example).

A sensor of an image forming apparatus disclosed in JP 10-20582 A detects the amount of moisture adsorbed by the developer contained in the developing device. The image forming apparatus disclosed in JP 10-20582 A performs control on the developer, for example, on the basis of the detected amount of adsorbed moisture. The control on the developer is control on determination as to whether the supply of the developer is needed, for example.

In the image forming apparatus disclosed in JP 10-20582 A, however, the value of the atmospheric pressure at the place where the image forming apparatus is installed is not taken into consideration. Therefore, there is a problem that the image forming apparatus cannot perform any processing on the developer while taking the atmospheric pressure value into consideration.

### SUMMARY

The present disclosure has been made to solve the above problem, and an object in one aspect is to provide an image forming apparatus and a control method for performing processing based on the concentration of the developer while taking into consideration the value of the atmospheric pressure at the installation position of the image forming apparatus.

To achieve the abovementioned object, according to an aspect of the present invention, an image forming apparatus reflecting one aspect of the present invention comprises: a latent image carrier on which a latent image is formed; a developing device that stores a developer, and develops the latent image formed on the latent image carrier using the developer; a concentration acquirer that acquires a concentration of the developer stored in the developing device; an atmospheric pressure acquirer that acquires an atmospheric pressure value at a position in which the image forming apparatus is installed; and a corrector that corrects the concentration detected by the concentration acquirer, on the basis of the atmospheric pressure value acquired by the atmospheric pressure acquirer.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing an example internal structure of an image forming apparatus according to an embodiment;

FIG. 2 is a diagram showing an example of a developing device;

FIG. 3 is a diagram showing an example of stirring screws;

FIG. 4 is a block diagram showing the hardware configuration of the image forming apparatus;

FIG. 5 shows an example of results of an experiment using a permeability sensor;

FIG. 6 is a diagram showing an example of a first correction table;

FIG. 7 is a diagram showing an example of the functional configuration of a control device;

FIG. 8 is a flowchart showing a process to be performed in the image forming apparatus of this embodiment;

FIG. 9 is a diagram showing an example of a second correction table;

FIG. 10 is a diagram showing an example of an image forming system; and

FIG. 11 is a diagram showing an example of a table held by a server device.

### DETAILED DESCRIPTION OF EMBODIMENTS

Hereinafter, one or more embodiments of the present invention will be described with reference to the drawings. However, the scope of the invention is not limited to the disclosed embodiments. In the description below, like components and constituent elements are denoted by like reference numerals. Like components and constituent elements also have like names and functions. Therefore, detailed explanation of them will not be unnecessarily repeated. It should be noted that the embodiments and the modifications described below may be selectively combined as appropriate.

### First Embodiment

[Internal Structure of an Image Forming Apparatus]

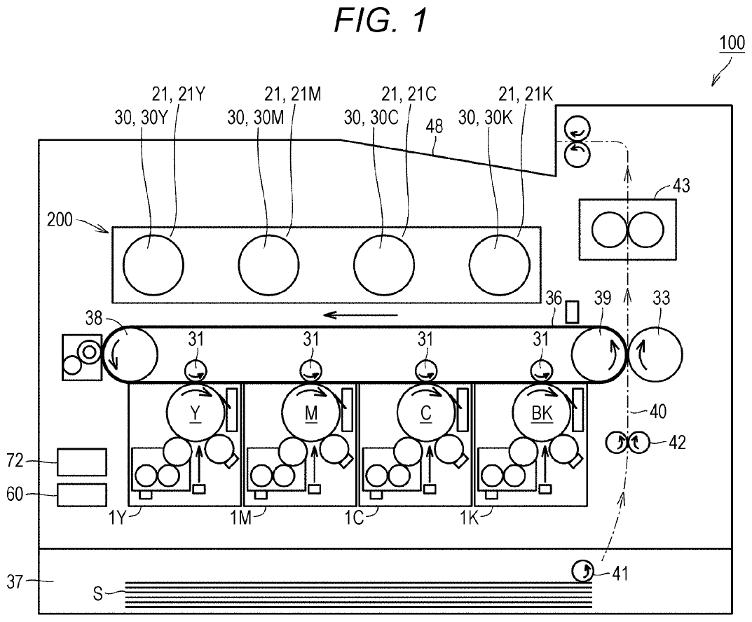

Referring to FIG. 1, the internal structure of an image forming apparatus 100 is described. FIG. 1 is a diagram showing an example internal structure of the image forming apparatus 100.

The image forming apparatus 100 as a color printer is shown in FIG. 1. Although the image forming apparatus 100 as a color printer will be described below, the image forming apparatus 100 is not necessarily a color printer. For example, the image forming apparatus 100 may be a monochrome printer, a copying machine, a facsimile machine, or a multi-functional peripheral (MFP). In this embodiment, the developer is assumed to be toner.

The image forming apparatus 100 includes image forming units 1Y, 1M, 1C, and 1K, an intermediate transfer belt 36, primary transfer rollers 31, a secondary transfer roller 33, a cassette 37, a driven roller 38, a driving roller 39, a pick-up roller 41, timing rollers 42, and a fixing device 43.

The image forming units 1Y, 1M, 1C, and 1K are sequentially arranged along the intermediate transfer belt 36. The image forming unit 1Y forms a yellow (Y) toner image. The image forming unit 1M forms a magenta (M) toner image. The image forming unit 1C forms a cyan (C) toner image. The image forming unit 1K forms a black (BK) toner image.

The image forming units 1Y, 1M, 1C, and 1K and the intermediate transfer belt 36 are in contact with each other at portions where the primary transfer rollers 31 are disposed. The primary transfer rollers 31 are designed to be rotatable. As a transfer voltage of the opposite polarity of that of the toner images is applied to the primary transfer rollers 31, the toner images are transferred from the image forming units 1Y, 1M, 1C, and 1K onto the intermediate transfer belt 36.

In the case of a color print mode, the yellow (Y) toner image, the magenta (M) toner image, the cyan (C) toner image, and the black (BK) toner image are sequentially transferred onto the intermediate transfer belt 36 in an overlapping manner. As a result, a color toner image is formed on the intermediate transfer belt 36. In the case of a monochrome print mode, on the other hand, the black (BK) toner image is transferred from a photosensitive member 10 (a latent image carrier) onto the intermediate transfer belt 36.

The intermediate transfer belt 36 is stretched around the driven roller 38 and the driving roller 39. The driving roller 39 is rotationally driven by a motor (not shown), for example. The intermediate transfer belt 36 and the driven roller 38 rotate with the driving roller 39. As a result, the toner image on the intermediate transfer belt 36 is conveyed onto the secondary transfer roller 33.

Paper sheets S are stored in the cassette 37. The paper sheets S are sent one by one from the cassette 37 to the secondary transfer roller 33 along a conveyance path 40 by the pick-up roller 41 and the timing rollers 42. The secondary transfer roller 33 applies a transfer voltage of the opposite polarity of that of the toner image to the paper sheet S being conveyed. As a result, the toner image is attracted to the secondary transfer roller 33 from the intermediate transfer belt 36, and is transferred to an appropriate position on the paper sheet S.

The fixing device 43 applies pressure and heat to the paper sheet S passing through the fixing device 43. As a result, the toner image formed on the paper sheet S is fixed to the paper sheet S. After that, the paper sheet S is ejected onto a tray 48.

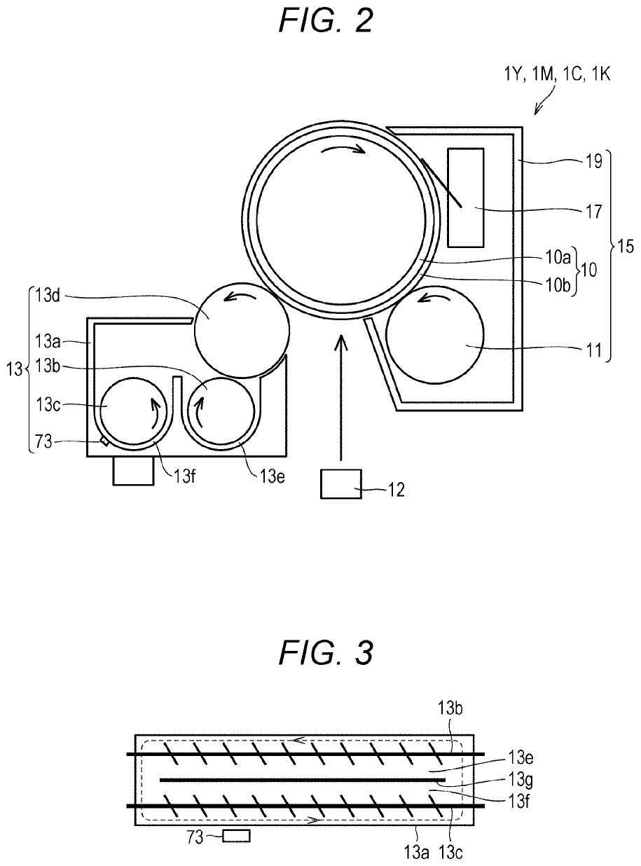

Next, a toner supplier 200 (a supplier) will be described. The image forming apparatus 100 further includes the toner supplier 200. The toner supplier 200 is a device for supplying toner to each developing device 13 (see FIG. 2). The toner supplier 200 is disposed between the intermediate transfer belt 36 and the tray 48 in the vertical direction.

The toner supplier 200 includes container holders 21 (21Y, 21M, 21C, and 21K) for the respective colors and toner bottles 30 (30Y, 30M, 30C, and 30K) for the respective colors. The toner bottles 30 are also referred to as the supply members.

The toner bottles 30 contain the toner to be supplied to the developing devices 13. The toner bottle 30Y, the toner bottle 30M, the toner bottle 30C, and the toner bottle 30K correspond to the respective developing devices 13 of the image forming unit 12Y, the image forming unit 12M, the image forming unit 12C, and the image forming unit 12K. In other words, the toner bottle 30Y, the toner bottle 30M, the toner bottle 30C, and the toner bottle 30K contain toners of yellow (Y), magenta (M), cyan (C), and black (K).

The container holders 21 are secured to the image forming apparatus 100. The toner bottles 30 are detachably attached to the container holders 21. The container holders 21 are designed to accommodate the toner bottles 30. The container holder 21Y, the container holder 21M, the container holder 21C, and the container holder 21K correspond to the toner bottle 30Y, the toner bottle 30M, the toner bottle 30C, and the toner bottle 30K, respectively.

When the image forming apparatus 100 is in operation, toner is supplied to the developing devices 13 from the toner bottles 30 attached to the container holders 21. In a case where the toner in a toner bottle 30 has decreased in quantity, the user removes the toner bottle 30 from the container holder 21, and attaches a new toner bottle 30 to the container holder 21.

[Internal Structure of an Image Forming Unit]

Referring now to FIG. 2, the internal structure of the image forming units 1Y, 1M, 1C, and 1K is described. FIG. 2 is a diagram showing an example internal structure of the image forming units 1Y, 1M, 1C, and 1K.

As shown in FIG. 2, each of the image forming units 1Y, 1M, 1C, and 1K includes a drum unit 15, an exposure device 12, and a developing device 13.

The drum unit 15 includes a photosensitive member 10, a charging device 11, a cleaning device 17, and a support 19.

The support 19 supports the photosensitive member 10, the charging device 11, and the cleaning device 17, to turn these components into a unit.

The photosensitive member 10 includes a drum-like (cylindrical) substrate 10a made of aluminum or the like, and a photosensitive layer 10b formed on the outer circumferential surface of the substrate 10a. A toner image is formed on the outer circumferential surface of the photosensitive member 10.

The charging device 11 is a roller that uniformly and negatively charges the peripheral surface of the photosensitive member 10. The charging device 11 has an elongated shape along the rotation axis of the photosensitive member 10. The rotation axis of the charging device 11 is parallel to the rotation axis of the photosensitive member 10.

The charging device 11 includes a columnar shaft that is formed with a metal (such as a stainless material) and has rigidity, and an elastic layer formed with a conductive or semiconductive elastic material on the peripheral surface of the shaft.

The cleaning device 17 is pressed against the photosensitive member 10. The cleaning device 17 collects the toner remaining on the surface of the photosensitive member 10 after the toner image transfer.

The exposure device 12 emits laser light onto the photosensitive member 10 in accordance with a control signal from a control device 60 that will be described later, and exposes the surface of the photosensitive member 10 in accordance with an image pattern that has been input thereto. As a result, electric charges are generated in the exposed portion by the charge generation layer of the photosensitive layer 10b, and the absolute value of the surface potential (negative polarity) of the exposed portion becomes lower than the absolute value of the surface potential (negative polarity) of the unexposed portion. In this manner, an electrostatic latent image corresponding to the input image is formed on the photosensitive member 10.

In this embodiment, the developing device 13 develops the electrostatic latent image formed on the surface of the photosensitive member 10 with toner (or using toner). The developing device 13 includes a developing tank 13a, a pair of stirring screws 13b and 13c, a toner concentration sensor 73, and a developing roller 13d. As the developing device 13 develops the electrostatic latent image, the toner in the developing device 13 decreases in quantity.

The developing tank 13a contains a two-component developer that includes a nonmagnetic toner and a carrier formed with ferrite powder, iron powder, or the like. The developing tank 13a has two storage chambers 13e and 13f parallel to the axial direction of the photosensitive member 10. The two storage chambers 13e and 13f communicate with each other at both ends. The stirring screws 13b and 13c are disposed in the storage chambers 13e and 13f, respectively. The stirring screws 13b and 13c extend from the front side toward the back side of FIG. 2. When the stirring screws 13b and 13c are rotated, the two-component developer stored in the storage chambers 13e and 13f is stirred in the process of circulating between the storage chambers 13e and 13f. Thus, the toner and the carrier are mixed together, and are frictionally charged. The stirring screws 13b and 13c are also referred to as the “stirrers”.

The resin particles forming the toner that is used as the two-component developer of this embodiment, and the resin material that coats the carrier surfaces are selected so that the toner has negative charging characteristics, and the carrier has positive charging characteristics. Accordingly, as friction is caused by stirring, the toner is negatively charged, and the carrier is positively charged. The negatively charged toner then adheres to the periphery of the positively charged carrier.

The developing roller 13d is a nonmagnetic cylindrical member formed with a stainless material, for example. The developing roller 13d contains a magnet (not shown) having a plurality of magnetic poles, and is driven to rotate, with a narrow gap being kept with the photosensitive member 10.

The two-component developer that is conveyed in the axial direction of the stirring screw 13b in the storage chamber 13e, or the carrier to which the toner is attached, adheres to the peripheral surface of the developing roller 13d by virtue of the magnet contained in the developing roller 13d.

The rotating developing roller 13d conveys the two-component developer adhering to the peripheral surface to a position (a development region) facing the photosensitive member 10.

A voltage supplied from the power supply unit 50 described later is applied to the developing roller 13d. A voltage obtained by superimposing an AC voltage on a DC voltage is applied to the developing roller 13d. When the electrostatic latent image forming portion reaches the position (the development region) facing the developing roller 13d by virtue of the rotation of the photosensitive member 10, the toner (negatively charged) separates from the carrier on the peripheral surface of the developing roller 13d, and moves onto the photosensitive member 10. At this stage, the carrier is attracted to the developing roller 13d by the magnetic force of the magnet contained in the developing roller 13d, and does not move onto the photosensitive member 10. In this manner, the toner is transferred from the developing roller 13d onto the photosensitive member 10, and a toner image corresponding to the electrostatic latent image is developed on the surface of the photosensitive member 10.

The toner concentration sensor 73 detects the toner concentration of the two-component developer in the developing tank 13a. The toner concentration is also referred to as “Tc”. The toner concentration sensor 73 is typically a permeability sensor. The toner concentration sensor 73 (a permeability sensor) detects the density of the carrier per unit volume. The carrier is primarily formed with iron. In a case where the permeability is high, it is assumed that the carrier is large in quantity, and accordingly, the Tc is low. In a case where the permeability is low, on the other hand, it is assumed that the carrier is small in quantity, and accordingly, the Tc is high. The toner concentration sensor 73 also converts the permeability detected by the permeability sensor into Tc. The method of conversion may be a method using a predetermined mathematical formula. Alternatively, the method of conversion may be a method using a predetermined table. Note that the conversion from the permeability to Tc may be performed by the control device 60.

The toner concentration sensor 73 is preferably oriented in the vertical direction of the stirring screw 13c so as not to be easily affected by the height of the liquid level of the toner in the developing tank 13a. Further, the toner concentration sensor 73 may be disposed on either the stirring screw 13b closer to the developing roller 13d or the stirring screw 13c farther from the developing roller 13d. To improve the responsiveness to toner consumption, the toner concentration sensor 73 may be disposed on the stirring screw 13b closer to the developing roller 13d. Furthermore, the position of the toner concentration sensor 73 in the axial direction of the stirring screw 13c is preferably a position at which the carrier and the toner have been sufficiently stirred.

The toner concentration typically means (toner weight)/(toner weight +carrier weight). An appropriate range is set beforehand for the toner concentration in the developing tank 13a. The appropriate range includes a lower limit and an upper limit. For example, the lower limit is 5 parts by weight, and the upper limit is 8 parts by weight. “The Tc is lower than the appropriate range” means that the Tc is lower than the lower limit. Further, “the Tc is higher than the appropriate range” means that the Tc is higher than the upper limit. Alternatively, the appropriate range, the lower limit, and the upper limit may be expressed in percentage.

When the image forming apparatus 100 performs a printing process in a state where the Tc is lower than the appropriate range, the toner amount of the image to be developed becomes smaller, and the density of the printed image is lower than an appropriate density. The appropriate density is a density designated (input) by the user, for example.

In a state where the Tc is higher than the appropriate range, on the other hand, the toner might not be sufficiently stirred relative to the carrier. In such a case, the charge amount relative to the toner decreases, and the toner is scattered from the developing device 13. When the toner is scattered from the developing device 13, the toner is added to the inside of the image forming apparatus 100 or a background portion of an image (a portion to which the toner should not be added), for example, and a phenomenon such as an image defect occurs. Therefore, the Tc preferably stays within the appropriate range.

FIG. 3 is a side view of the pair of stirring screws 13b and 13c shown in FIG. 2. As shown in FIG. 3, when the first stirring screw 13b and the second stirring screw 13c rotate, the developer stored in the developing tank 13a is conveyed in the direction indicated by arrows and a dashed line. The developer is stirred by the conveyance. Further, a partition portion 13g is provided between the first stirring screw 13b and the second stirring screw 13c. The partition portion 13g divides the inside of the developing tank 13a into the first storage chamber 13e and the second storage chamber 13f. The partition portion 13g extends in a direction parallel to the axial direction of the developing roller 13d so that the developer can be transferred between the first storage chamber 13e and the second storage chamber 13f from either end. Although not specifically shown in FIG. 3, a receiving port for receiving the toner supplied from the toner supplier 200 is provided at a predetermined position in FIG. 3.

[Hardware Configuration of the Image Forming Apparatus]

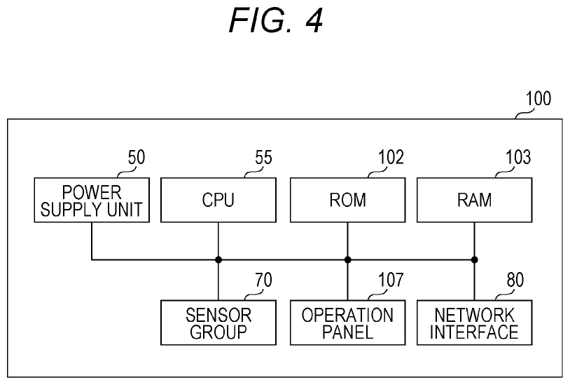

Referring now to FIG. 4, an example of the hardware configuration of the image forming apparatus 100 is described. FIG. 4 is a block diagram showing the principal hardware configuration of the image forming apparatus 100.

As shown in FIG. 4, the image forming apparatus 100 includes a power supply unit 50, a central processing unit (CPU) 55, a sensor group 70, a read only memory (ROM) 102, a random access memory (RAM) 103, an operation panel 107, and a network interface 80.

The power supply unit 50 supplies power to the respective components (such as the charging device 11 and the developing device 13 in FIG. 2) of the image forming apparatus 100. The CPU 55 executes a program. The ROM 102 stores data in a nonvolatile manner. The RAM 103 stores data in a volatile manner.

The sensor group 70 is formed with a plurality of sensors that measure various physical quantities in the image forming apparatus 100. The sensor group 70 includes an atmospheric pressure sensor 72, and a toner concentration sensor 73 shown in FIG. 2.

The operation panel 107 is formed with a display and a touch screen. The display and the touch screen are disposed on each other. The operation panel 107 receives an instruction directed to the image forming apparatus 100 (such as a printing instruction or a scanning instruction) from the user, for example.

The network interface 80 is connected to a network. The image forming apparatus 100 can communicate with an external device via the network interface 80. Examples of such external devices include mobile communication terminals such as smartphones, and servers.

[Toner Supply]

When the control device 60 determines that the Tc acquired by the toner concentration sensor 73 is not within the appropriate range, the control device 60 identifies the amount necessary for the Tc to fall within the appropriate range. In other words, “the amount necessary for the Tc to fall within the appropriate range” is “the amount requested to be supplied from a toner bottle 30 to the corresponding developing device 13”.

The control device 60 controls and causes the toner supplier 200 to supply the requested amount (the amount to be supplied) of toner from the toner bottle 30 to the developing device 13. As for the carrier, the control device 60 controls and causes a carrier supplier (not shown) to supply the carrier from the carrier supplier to the developing device 13.

In some cases, the image forming apparatus 100 is installed at a position in which the pressure value is not equal to a reference value. The position in which the pressure value is not equal to the reference value is a highland, for example.

The relationship between the atmospheric pressure value and the toner is now described. For example, a case where the image forming apparatus 100 is installed at a first position is compared with a case where the image forming apparatus 100 is installed at a second position in which the atmospheric pressure value is lower than that at the first position. The first position is a position in a flatland, and the second position is a position at a high altitude (a highland).

The toner is formed with a large number of toner particles in the form of powder. That is, a large number of toner particles is stored in the developing tank 13a as the toner. Further, the atmospheric pressure is lower at the second position than at the first position. Accordingly, the distance between adjacent toner particles is longer at the second position than at the first position. As a result, the bulk density of the toner stored in the developing tank 13a is lower at the second position than at the first position.

As described above, the toner concentration sensor 73 (the permeability sensor) detects the density of the carrier per unit volume. In a case where the value of the atmospheric pressure at the position in which the image forming apparatus 100 is disposed is low, the air content per unit volume is higher than in a case where the value of the atmospheric pressure at the position in which the image forming apparatus 100 is disposed is high. Therefore, the toner concentration sensor 73 eventually detects the air per unit volume as the toner. Accordingly, in a case where the value of the atmospheric pressure at the position in which the image forming apparatus 100 is disposed is low, the value detected by the toner concentration sensor 73 is smaller than the actual toner concentration. Therefore, in a case where the value of the atmospheric pressure at the position in which the image forming apparatus 100 is disposed is low, it is not possible to detect an accurate toner concentration.

Next, changes in the output of the toner concentration sensor 73 (the permeability sensor) are described. The developer is stirred in the developing tank 13a. Therefore, it can be assumed that the toner is uniformly scattered in the air in the developing tank 13a.

In this case, the relationship V=A·T/P is established, according to the Boyle's law. V represents the volume, A represents the constant, T represents the temperature, and P represents the pressure. As can be seen from the Boyle law, the volume V of the developer varies with the bulk density (pressure P). Further, as a result of examination of changes in the volume in the image forming apparatus 100 at different places, the results described below were obtained.

It was found that, in a case where the atmospheric pressure at the position in which the image forming apparatus 100 was disposed changed from 1010 hPa (0 m above sea level) to 810 hPa (2000 m above sea level), the volume V changed by 20%. It was also found that, in a case where the temperature at the position in which the image forming apparatus 100 was disposed changed from 10 degrees C. (283 K) to 30 degrees C. (303 K), the volume V changed by 7%.

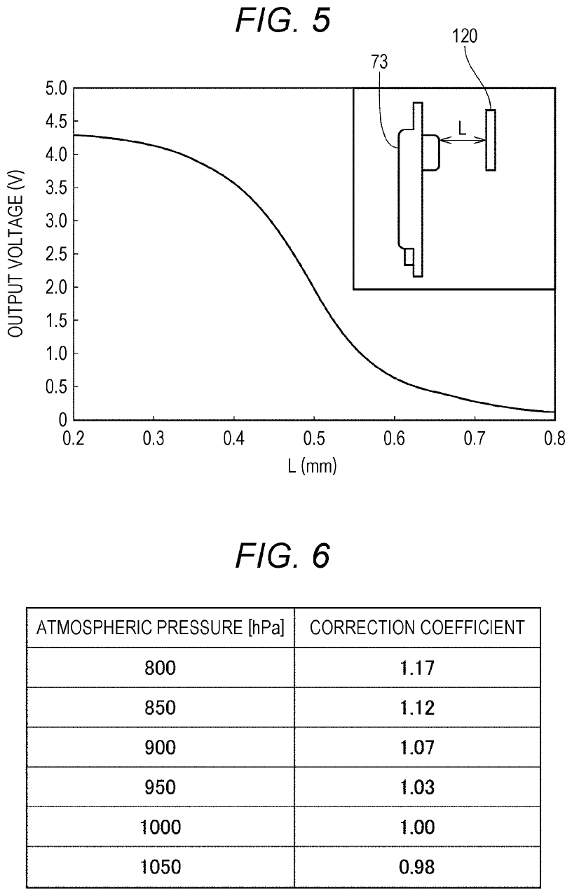

FIG. 5 shows an example of results of an experiment using the toner concentration sensor 73 (the permeability sensor). As shown in the upper right portion of FIG. 5, the experiment was conducted with the toner concentration sensor 73 and a disk-like ferrite plate 120. In this experiment, the carrier was not used, but the disk-like ferrite plate 120 was used. The disk-like ferrite plate 120 is formed with a magnetic material like the carrier. In this experiment, the output voltage of the toner concentration sensor 73 was measured, with the carrier being imitated by the disk-like ferrite plate 120.

In this experiment, the distance L between the sensor surface 73a of the toner concentration sensor 73 and the disk-like ferrite plate 120 was changed in a plurality of stages, and the value of the voltage output from the toner concentration sensor 73 was measured each time the change was made. As described above, in a case where the value of the atmospheric pressure at the position in which the image forming apparatus 100 is disposed is low, the distance between adjacent toner particles is long. Therefore, such a situation can be considered a situation in which the distance L is long. In a case where the value of the atmospheric pressure at the position in which the image forming apparatus 100 is disposed is high, on the other hand, the distance between adjacent toner particles is short. Therefore, such a situation can be considered a situation in which the distance L is short.

As shown in FIG. 5, the longer the distance L, the higher the voltage V output from the toner concentration sensor 73. That is, in a case where a desired amount of toner is stored in the developing tank 13a, and the value of the atmospheric pressure at the position in which the image forming apparatus 100 is disposed is low, the bulk density of the toner is low, which means that L is large. Accordingly, the output voltage V is low. In a case where the value the atmospheric pressure at the position in which the image forming apparatus 100 is disposed is high, on the other hand, the bulk density of the toner is high, which means that L is small. Accordingly, the output voltage V is high. Thus, it is apparent from FIG. 5 that, in a case where a desired amount of toner is stored in the developing tank 13a, the voltage V output from the toner concentration sensor 73, or the result of detection conducted by the toner concentration sensor 73, varies with the value of the atmospheric pressure at the position in which the image forming apparatus 100.

[First Correction Table]

Next, a first correction table is described. FIG. 6 is a diagram showing an example of the first correction table. In the first correction table shown in FIG. 6, atmospheric pressure values are associated with correction coefficients. The correction coefficients are values to be multiplied by toner concentrations detected by the toner concentration sensor 73. As described above, in a case where the value of the atmospheric pressure at the position in which the image forming apparatus 100 is disposed is low, the toner concentration sensor 73 detects a toner concentration that is lower than the actual toner concentration. Therefore, the first correction table in FIG. 6 is designed so that the correction coefficient increases as the atmospheric pressure value decreases. For example, in a case where the value of the atmospheric pressure at the position in which the image forming apparatus 100 is disposed is 800 hPa, the correction coefficient is set at 1.17. In a case where the value of the atmospheric pressure is 850 hPa, the correction coefficient is set at 1.12. In a case where the value of the atmospheric pressure is 1000 hPa (for example, a case where the image forming apparatus 100 is installed in a flatland), the correction coefficient is set at 1.00. The correspondence between the atmospheric pressure values and the correction coefficients specified in the first correction table is determined beforehand through experiments or the like.

[Example Functional Configuration and the Like of the Control Device 60]

Next, an example functional configuration and the like of the control device 60 are described. The control device 60 has the functions of a concentration acquirer 61, an atmospheric pressure acquirer 62, a corrector 63, a determiner 65, an executor 66, and a storage 67. The atmospheric pressure sensor 72 and the toner concentration sensor 73 are connected to the control device 60. The storage 67 stores beforehand the first correction table described above with reference to FIG. 6.

A temperature sensor 74 and a temperature acquirer 64 indicated by dashed lines will be described later in the second embodiment. The concentration acquirer 61 acquires the toner concentration detected by the toner concentration sensor 73 (which is the concentration of the toner stored in the developing tank 13a). The concentration acquirer 61 transmits the toner concentration acquired by the concentration acquirer 61 to the corrector 63.

Meanwhile, the atmospheric pressure acquirer 62 acquires the atmospheric pressure value detected by the atmospheric pressure sensor 72 (which is the value of the atmospheric pressure at the position in which the image forming apparatus 100 is installed). The atmospheric pressure acquirer 62 transmits the atmospheric pressure value acquired by the atmospheric pressure acquirer 62 to the corrector 63.

The corrector 63 corrects the toner concentration detected by the toner concentration sensor 73 (the toner concentration acquired by the concentration acquirer 61), on the basis of the atmospheric pressure value acquired by the atmospheric pressure acquirer 62. For example, the corrector 63 refers to the first correction table, and identifies the correction coefficient corresponding to the atmospheric pressure value. In a case where the atmospheric pressure value transmitted from the atmospheric pressure acquirer 62 is 800 hPa, for example, the corrector 63 identifies 1.17 as the correction coefficient. In a case where the atmospheric pressure value transmitted from the atmospheric pressure acquirer 62 is 1000 hPa, for example, the corrector 63 identifies 1.00 as the correction coefficient.

Further, in a case where the atmospheric pressure value acquired by the atmospheric pressure acquirer 62 does not match the atmospheric pressure value specified in the first correction table, an approximation process is performed so that the atmospheric pressure value acquired by the atmospheric pressure acquirer 62 approximates the atmospheric pressure value specified in the first correction table.

The approximation process includes at least one of the following processes: a process of complementing the atmospheric pressure value acquired by the atmospheric pressure acquirer 62, a process of rounding off the atmospheric pressure value to a predetermined number of digits, a process of rounding up the atmospheric pressure value to a predetermined number of digits, a process of rounding down the atmospheric pressure value to a predetermined number of digits, and the like.

The corrector 63 then multiplies the toner concentration transmitted from the concentration acquirer 61 by the correction coefficient identified by the corrector 63. Hereinafter, the toner concentration multiplied by the correction coefficient will be referred to as the “corrected toner concentration”. The corrector 63 outputs the corrected toner concentration to the determiner 65.

The determiner 65 determines whether the toner concentration corrected by the corrector 63 (the corrected toner concentration) is within the appropriate range (5 to 8 parts by weight in this embodiment) of the toner concentration stored in the developing tank 13a. The determiner 65 outputs the determination result to the executor 66.

The executor 66 performs the process corresponding to the determination result. For example, in a case where the determination result is that “the corrected toner concentration is lower than the lower limit”, the executor 66 outputs a toner supply signal to the toner supplier 200. The toner supply signal is a signal that indicates that the toner supplier 200 is to supply the developing device 13 with toner, and also indicates the amount of toner to be supplied by the toner supplier 200. Upon receipt of the toner supply signal, the toner supplier 200 supplies the developing device 13 with the amount of toner specified by the toner supply signal.

In a case where the determination result is that “the corrected toner concentration is higher than the upper limit”, the executor 66 performs control so that the toner concentration is lowered. In this control, a carrier supply signal is output to the carrier supplier, for example. The carrier supply signal is a signal for causing the carrier supplier to supply the carrier to the developing device 13. Alternatively, in a case where the determination result is that “the corrected toner concentration is higher than the upper limit”, the executor 66 may not perform any process.

In a case where the determination result is that “the corrected toner concentration is within the appropriate range”, the executor 66 does not perform any process.

[Flowchart Relating to the Control Device 60]

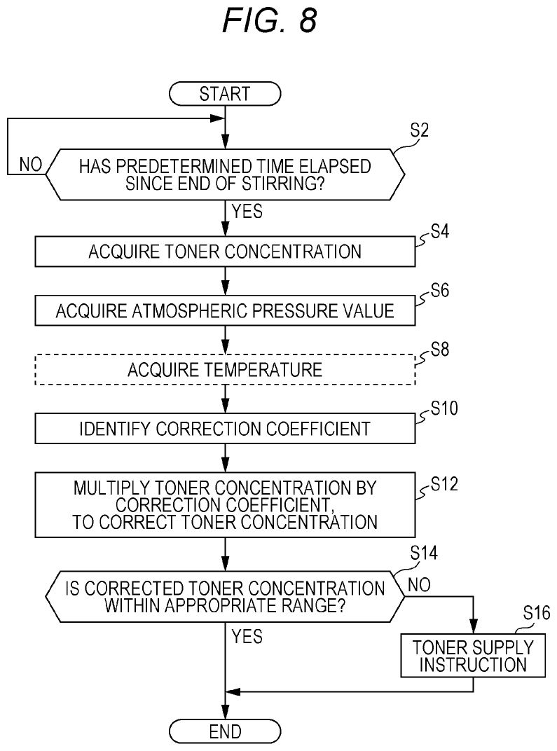

Next, a flowchart showing a process to be performed by the control device 60 is described. FIG. 8 is an example flowchart showing a process to be performed by the control device 60. First, in step S2, the control device 60 determines whether a predetermined time has elapsed since the stirring by the stirring screws 13b and 13c was completed. The predetermined time may be any time, and may be three seconds, for example. Alternatively, the predetermined time may be 0 second. In a case where the predetermined time is 0 second, “YES” is output as the determination result in step S2 at the time when the stirring by the stirring screws 13b and 13c is completed.

The stirring screws 13b and 13c stir the toner in the developing tank 13a when predetermined start conditions are satisfied. The start conditions include a condition that the image forming apparatus 100 is turned on, for example. The start conditions may also include other conditions.

In step S2, the control device 60 stands by until the predetermined time has elapsed since the time when the stirring by the stirring screws 13b and 13c was completed (step S2).

If the control device 60 determines that the predetermined time has elapsed since the time when the stirring by the stirring screws 13b and 13c was completed (YES in step S2), the process moves on to step S4.

In step S4, the concentration acquirer 61 acquires a toner concentration from the toner concentration sensor 73. In step S6, the atmospheric pressure acquirer 62 acquires an atmospheric pressure value from the atmospheric pressure sensor 72. Step S8 indicated by a dashed line will be described later in the second embodiment.

In step S10, the corrector 63 refers to the first correction table (FIG. 6), and identifies the correction coefficient corresponding to the atmospheric pressure value acquired in step S6. In step S12, the corrector 63 multiplies the toner concentration acquired in step S4 by the correction coefficient identified in step S10.

In step S14, the determiner 65 determines whether the toner concentration corrected in step S12 is within the appropriate range. If the determiner 65 determines in step S14 that the corrected toner concentration is within the appropriate range (YES in step S14), any processing is not performed, and the process shown in FIG. 8 comes to an end. If the determiner 65 determines in step S14 that the corrected toner concentration is not within the appropriate range (NO in step S14), on the other hand, the process moves on to step S16.

In step S16, the executor 66 outputs a toner supply signal to the toner supplier 200 as a toner supply instruction process. Upon receipt of the toner supply signal, the toner supplier 200 supplies the developing device 13 with the amount of toner specified by the toner supply signal. After that, the process comes to an end.

[Effects of the Image Forming Apparatus of This Embodiment]

Next, the effects of the image forming apparatus 100 of this embodiment are described.

(1) The concentration acquirer 61 acquires the toner concentration detected by the toner concentration sensor 73 (which is the concentration of the toner stored in the developing tank 13a) (step S4). Meanwhile, the atmospheric pressure acquirer 62 acquires the atmospheric pressure value detected by the atmospheric pressure sensor 72 (which is the value of the atmospheric pressure at the position in which the image forming apparatus 100 is installed) (step S6). The corrector 63 then corrects the toner concentration detected by the toner concentration sensor 73, on the basis of the value of the atmospheric pressure at the position in which the image forming apparatus 100 is installed. Accordingly, the image forming apparatus 100 of this embodiment can detect a toner concentration with which a decrease in the bulk density of the toner due to the atmospheric pressure value is avoided. As a result, the image forming apparatus 100 can perform control based on the toner concentration taking into consideration the value of the atmospheric pressure at the position in which the image forming apparatus 100 is installed.

In a case where the image forming apparatus 100 is installed at a place where the pressure value is low, for example, there is the need to prepare a configuration for increasing the pressure value at the position in which a toner concentration is detected. Such a configuration may be a first configuration in which the diameter of the toner conveyance path is made smaller at the position in which the toner concentration sensor 73 performs detection, for example. Alternatively, such a configuration may be a second configuration in which the shape of each screw is changed to convey toner, for example. In such a configuration, however, toner retention or the like might occur. If the toner remains, appropriate printing cannot be performed in a case where high-coverage printing is to be performed, for example.

In this embodiment, the image forming apparatus 100 does not need to have either of the first configuration and the second configuration. That is, it is possible to accurately detect a toner concentration while taking into consideration the value of the pressure at the position in which the image forming apparatus 100 is disposed, without any toner retention or the like.

(2) Further, the corrector 63 corrects the toner concentration so that, the lower the atmospheric pressure value acquired by the atmospheric pressure acquirer 62, the higher the toner concentration detected by the toner concentration sensor 73, as shown in FIG. 6. Through such correction, the image forming apparatus 100 of this embodiment can detect a toner concentration with which a decrease in the bulk density of the toner due to the atmospheric pressure value is avoided.

(3) Further, the determiner 65 determines whether the toner concentration corrected by the corrector 63 (the corrected toner concentration) is within the predetermined appropriate range (step S14). The executor 66 performs the process corresponding to the result of the determination performed by the determiner 65. Thus, the executor 66 (the image forming apparatus 100) can perform a process based on the toner concentration taking into consideration the value of the atmospheric pressure at the position in which the image forming apparatus 100 is installed.

(4) Further, in a case where the result of the determination performed by the determiner 65 is a result indicating that the corrected toner concentration is lower than the appropriate range, or that the corrected toner concentration is lower than the lower limit, the executor 66 performs a process to cause the toner supplier 200 to supply toner to the developing device 13. In this embodiment, this process is a process of outputting a toner supply signal to the toner supplier 200. Thus, the image forming apparatus 100 can perform appropriate toner supply, on the basis of the toner concentration taking into consideration the value of the atmospheric pressure at the position in which the image forming apparatus 100 is installed.

(5) In this embodiment, a permeability sensor is used as the toner concentration sensor 73. Thus, the image forming apparatus 100 can detect a toner concentration, using a known sensor.

(6) Further, the stirrer (the stirring screws 13b and 13c) stirs the toner contained in the developing device 13. Thus, the image forming apparatus 100 can appropriately charge the toner and the carrier. Further, as shown in step S2 in FIG. 8, the concentration acquirer 61 acquires the toner concentration when the predetermined time has elapsed since the time when the stirring process performed by the stirrer was completed.

In a case where the concentration acquirer 61 acquires the toner concentration before the stirring process to be performed by the stirrer, the toner might be sunk in the developing tank 13a. In this case, the toner concentration acquired by the concentration acquirer 61 is the concentration of the toner sunk in the developing tank 13a, and is not an accurate toner concentration. Therefore, in this embodiment, the concentration acquirer 61 acquires the toner concentration when the predetermined time has elapsed since the time when the stirring process performed by the stirrer was completed. Thus, the concentration acquirer 61 can acquire an accurate toner concentration.

In a modification, when the predetermined time has elapsed since the time when the stirring process performed by the stirrer was completed, the toner concentration sensor 73 may start detecting the toner concentration, and output the toner concentration to the concentration acquirer 61.

(7) Further, the storage 67 stores the first correction table (FIG. 6). The first correction table is information in which atmospheric pressure values are associated with correction coefficients. The corrector 63 also identifies the correction coefficient corresponding to the atmospheric pressure value acquired by the atmospheric pressure acquirer 62 in the first correction table. The corrector 63 further multiplies the concentration acquired by the concentration acquirer 61 by the identified correction coefficient, to correct the concentration. Accordingly, the image forming apparatus 100 of this embodiment can detect a toner concentration with which a decrease in the bulk density of the toner due to the atmospheric pressure value is avoided. As a result, the image forming apparatus 100 can perform control based on the toner concentration taking into consideration the value of the atmospheric pressure at the position in which the image forming apparatus 100 is installed.

(8) The image forming apparatus 100 further includes the atmospheric pressure sensor 72. The atmospheric pressure acquirer 62 acquires an atmospheric pressure value from the atmospheric pressure sensor 72. With such a configuration, the image forming apparatus 100 can acquire an atmospheric pressure value using components provided in the image forming apparatus 100.

### Second Embodiment

Next, an image forming apparatus 130 of a second embodiment is described. In the first embodiment, a toner concentration is corrected with a correction coefficient based on the value of the atmospheric pressure at the position in which the image forming apparatus 100 is installed, as described above. In the second embodiment, the toner concentration detected by the toner concentration sensor 73 is corrected with a correction coefficient based on the temperature as well as the atmospheric pressure value. This correction can further increase the accuracy of toner concentration correction.

The inventor has found that the toner bulk density is low at higher temperatures. Therefore, in this embodiment, a toner concentration is corrected with a correction coefficient that is designed to become higher as the atmospheric pressure value becomes smaller, and is designed to become higher as the temperature rises.

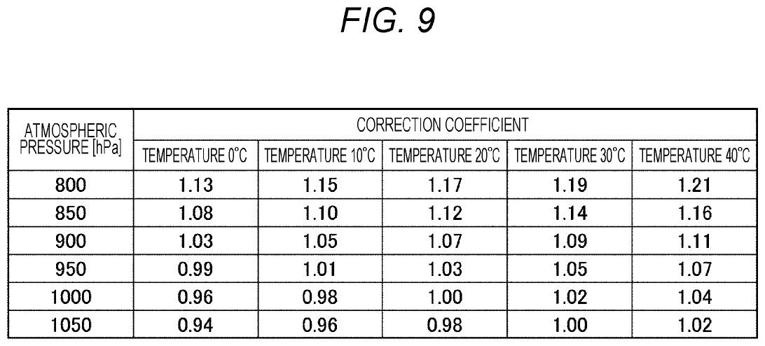

FIG. 9 is an example of a second correction table of this embodiment. The correction coefficient according to the second correction table in FIG. 9 is a number that becomes greater as the atmospheric pressure value becomes lower, and also becomes greater as the temperature rises.

According to the example shown in FIG. 9, in a case where the value of the atmospheric pressure at the position in which the image forming apparatus 100 is disposed is 800 hPa, and the temperature is 40 degrees C., the correction coefficient is set at 1.21. In a case where the value of the atmospheric pressure is 800 hPa, and the temperature is 10 degrees C., the correction coefficient is set at 1.15. The correspondence among the atmospheric pressure values, the temperatures, and the correction coefficients specified in the second correction table is determined beforehand through experiments.

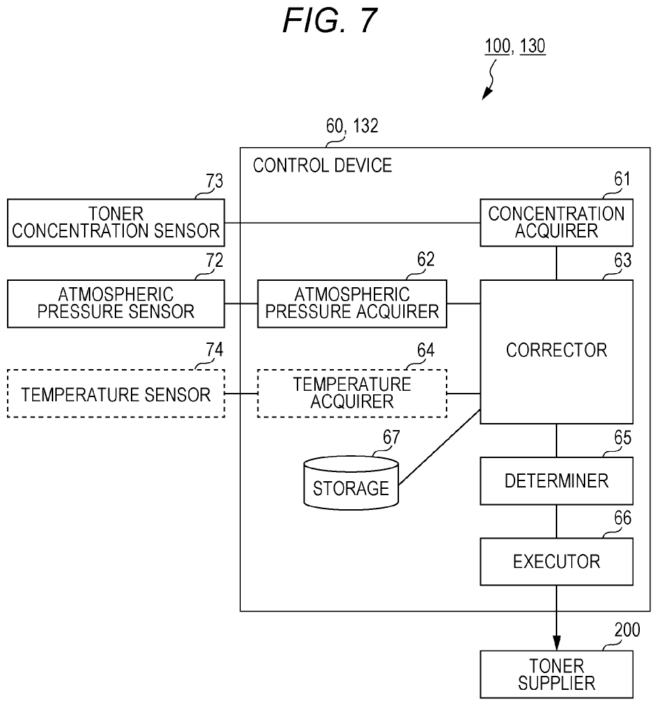

Referring now to FIG. 7, an example functional configuration of the image forming apparatus 130 of this embodiment is described. The image forming apparatus 130 further includes a temperature sensor 74 indicated by a dashed line, and a control device 132 of this embodiment further includes a temperature acquirer 64 indicated by a dashed line.

The temperature sensor 74 detects the temperature at the position in which the image forming apparatus 100 is disposed. The temperature acquirer 64 acquires the detected temperature. The corrector 63 corrects the concentration detected by the concentration acquirer 61, on the basis of the atmospheric pressure value acquired by the atmospheric pressure acquirer 62 and the temperature acquired by the temperature acquirer 64. For example, the corrector 63 refers to the table shown in FIG. 9, to identify the correction coefficient corresponding to the acquired atmospheric pressure value and the acquired temperature. For example, in a case where the acquired atmospheric pressure value is 800 hPa, and the acquired temperature is 40 degrees, 1.21 is identified as the correction coefficient.

The corrector 63 then multiplies the toner concentration transmitted from the concentration acquirer 61 by the correction coefficient identified by the corrector 63. The processes that follow are the same as those of the first embodiment.

Referring now to FIG. 8, a flowchart showing a process to be performed by the control device 132 is described. In this embodiment, the control device 132 performs the process in step S8 after the process in step S6, as indicated by a dashed line in FIG. 8.

In step S8, the temperature acquirer 64 acquires the temperature detected by the temperature sensor 74. In step S10, the corrector 63 refers to the table in FIG. 9, to identify the correction coefficient corresponding to the acquired atmospheric pressure value and the acquired temperature. The processes after step S12 are the same as those in the first embodiment. Note that the control device 132 may perform the process in step S8 before the process in step S6.

With the image forming apparatus 130 of this embodiment, it is possible to subject a toner concentration to correction that reflects not only the value of the atmospheric pressure at the position in which the image forming apparatus 130 is disposed, but also the temperature at the position in which the image forming apparatus 130 is disposed. Thus, this correction can further increase the accuracy of toner concentration correction.

### Third Embodiment

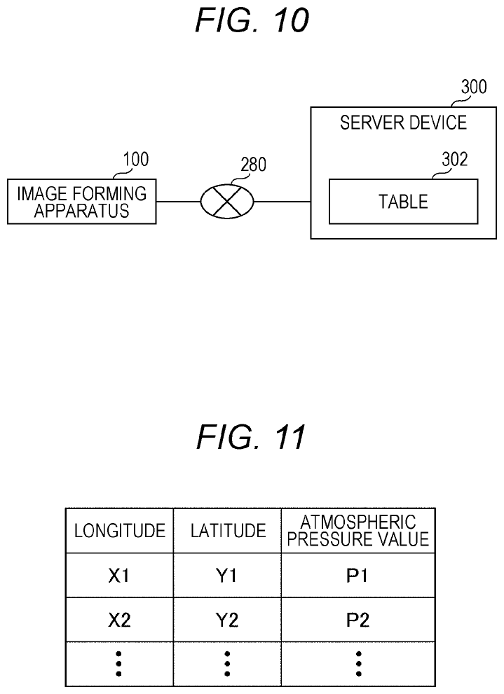

FIG. 10 shows an example configuration of an image forming system according to a third embodiment. In the example shown in FIG. 10, the image forming system includes an image forming apparatus 100, a server device 300, and a network 280. In the first and second embodiments, the atmospheric pressure sensor 72 detects the value of the atmospheric pressure at the position in which the image forming apparatus 100 is installed, as described above. In the third embodiment, the server device 300 detects the value of the atmospheric pressure at the position in which the image forming apparatus 100 is installed.

For example, in step S6 in FIG. 8, the image forming apparatus 100 requests the server device 300 for the value of the atmospheric pressure at the position in which the image forming apparatus 100 is installed. Regarding the request, the image forming apparatus 100 transmits a request signal to the server device 300 via the network 280, for example. The request signal contains positional information about the image forming apparatus 100 that is the transmission source of the request signal. The positional information is information indicating the position in which the image forming apparatus 100 is installed. The positional information typically includes the latitude and the longitude of the position in which the image forming apparatus 100 is installed.

The server device 300 holds an atmospheric pressure value table. FIG. 11 is a diagram showing an example of the atmospheric pressure value table. In the example shown in FIG. 11, atmospheric pressure values P are associated with latitudes X and longitudes Y. Further, the server device 300 updates the atmospheric pressure value table every time a predetermined time has elapsed (every time one day has passed, for example).

When the server device 300 acquires request information, the server device 300 acquires the positional information included in the request information. The server device 300 refers to the atmospheric pressure value table shown in FIG. 11, and acquires the atmospheric pressure value corresponding to the positional information. The acquired atmospheric pressure value serves as the value of the atmospheric pressure at the position in which the image forming apparatus 100 that has transmitted the request information is disposed. The server device 300 transmits the acquired atmospheric pressure value to the image forming apparatus 100 that is the request source. The image forming apparatus 100 acquires the acquired atmospheric pressure value, and performs the processes that follow.

With the image forming apparatus 100 of this embodiment, it is possible to acquire the atmospheric pressure value from an external device (the server device 300), and therefore, the image forming apparatus 100 does not need to include an atmospheric pressure value sensor. Thus, the number of components of the image forming apparatus 100 can be reduced.

### Modifications

Next, modifications are described.

The above embodiments include embodiments in which the atmospheric pressure acquirer 62 acquires an atmospheric pressure value from the atmospheric pressure sensor 72, and an embodiment in which the atmospheric pressure acquirer 62 acquires an atmospheric pressure value from the server device 300. However, in a situation where the value of the atmospheric pressure at the installation position of the image forming apparatus is not changed, for example, when the image forming apparatus is installed, a maintenance personnel or the like measures the atmospheric pressure value, and the storage 67 may store the atmospheric pressure value, for example. In the case of such a configuration, the atmospheric pressure acquirer 62 acquires the atmospheric pressure value stored in the storage 67. Further, in a case where the value of the atmospheric pressure at the current installation position is changed, such as where an image forming apparatus currently installed in a flatland is moved to and installed in a highland, for example, a maintenance personnel or the like may again measure the atmospheric pressure value when the image forming apparatus is installed in the highland, and the storage 67 may store the atmospheric pressure value.

Further, in the above embodiments, the corrector 63 corrects a toner concentration using the table shown in FIG. 6 or the table shown in FIG. 9, as described above. However, the corrector 63 may correct a toner concentration, using a correction formula based on one of the tables.

The correction formula in the first embodiment is such that a correction coefficient is output when the atmospheric pressure value acquired by the atmospheric pressure acquirer 62 is input. Further, the correction formula in the second embodiment is such that a correction coefficient is output when the atmospheric pressure value acquired by the atmospheric pressure acquirer 62 and the temperature acquired by the temperature acquirer 64 are input.

As described above, an image forming apparatus that corrects a toner concentration using a correction formula, instead of a table, can also achieve the same effects as those of the above described embodiments.

Further, in the above embodiments, a permeability sensor is used as the toner concentration sensor, as described above. Some other sensor may be used as the concentration detecting sensor. For example, a reflection density sensor may be used for color toner.

Further, in the above embodiments, the concentration acquirer 61 acquires a toner concentration, as described above. However, some other concentration of the developer may be acquired. For example, the concentration acquirer 61 may acquire the concentration of the carrier. In the case of such a configuration, a carrier concentration sensor is provided, instead of the toner concentration sensor 73.

Further, in the above embodiments, the developer is formed with a toner and a carrier, as described above. However, the developer may contain some other material. For example, the developer may be formed with a toner, not containing any carrier.

Although embodiments of the present invention have been described and illustrated in detail, the disclosed embodiments are made for purposes of illustration and example only and not limitation. The scope of the present invention should be interpreted not by terms of the above description but by terms of the appended claims, and it should be understood that equivalents of the claimed inventions and all modifications thereof are incorporated herein.

What is claimed is:

1. An image forming apparatus comprising:
a latent image carrier on which a latent image is formed;
a developing device that stores a developer, and develops the latent image formed on the latent image carrier using the developer;
a concentration acquirer that acquires a concentration of the developer stored in the developing device;
an atmospheric pressure acquirer that acquires an atmospheric pressure value at a position in which the image forming apparatus is installed; and
a corrector that corrects the concentration detected by the concentration acquirer, on the basis of the atmospheric pressure value acquired by the atmospheric pressure acquirer.

2. The image forming apparatus according to claim 1, wherein the corrector corrects the concentration to make the concentration detected by the concentration acquirer higher when the atmospheric pressure value acquired by the atmospheric pressure acquirer is lower.

3. The image forming apparatus according to claim 1, further comprising
a temperature acquirer that acquires a temperature at the position in which the image forming apparatus is installed,
wherein the corrector corrects the concentration detected by the concentration acquirer, on the basis of the atmospheric pressure value acquired by the atmospheric pressure acquirer and the temperature acquired by the temperature acquirer.

4. The image forming apparatus according to claim 1, further comprising:
a determiner that determines whether the concentration corrected by the corrector is within a predetermined appropriate range; and
an executor that performs a process corresponding to a result of the determination performed by the determiner.

5. The image forming apparatus according to claim 4, further comprising
a supplier that supplies the developer to the developing device,
wherein, when the result of the determination performed by the determiner is a result indicating that the concentration corrected by the corrector is lower than the appropriate range, the executor performs a process to cause the supplier to supply the developer to the developing device.

6. The image forming apparatus according to claim 1, further comprising
a permeability sensor that detects the concentration of the developer stored in the developing device,
wherein the concentration acquirer acquires the concentration detected by the permeability sensor.

7. The image forming apparatus according to claim 1, further comprising
a stirrer that stirs the developer stored in the developing device,
wherein, when a predetermined time elapses since a time when the developer has been stirred by the stirrer, the concentration acquirer starts detecting the concentration of the developer.

8. The image forming apparatus according to claim 1, further comprising
a storage that stores information in which the atmospheric pressure value is associated with a correction coefficient,
wherein the corrector multiplies the concentration acquired by the concentration acquirer by the correction coefficient associated in the information with the atmospheric pressure value acquired by the atmospheric pressure acquirer, to correct the concentration.

9. The image forming apparatus according to claim 1, further comprising
an atmospheric pressure sensor that detects the atmospheric pressure value,
wherein the atmospheric pressure acquirer acquires the atmospheric pressure value from the atmospheric pressure sensor.

10. The image forming apparatus according to claim 1, wherein the atmospheric pressure acquirer acquires the atmospheric pressure value from an external device.

11. A control method for controlling an image forming apparatus that stores a developer, and forms an image using the developer,
the control method comprising:
acquiring a concentration of the stored developer;
acquiring an atmospheric pressure value at a position in which the image forming apparatus is installed; and
correcting the detected concentration, on the basis of the acquired atmospheric pressure value.
